(19) United States
(12) Patent Application Publication
(10) Pub. No.: US 2020/0282843 A1
(43) Pub. Date: Sep. 10, 2020

(54) ELECTRIFIED VEHICLE HIGH-VOLTAGE DISCONNECT SYSTEM AND METHOD

(71) Applicant: FORD GLOBAL TECHNOLOGIES, LLC, Dearborn, MI (US)

(72) Inventors: Frederic STEFAN, Aachen (DE); Christoph ARNDT, Moerlen (DE); Uwe GUSSEN, Huertgenwald (DE)

(73) Assignee: FORD GLOBAL TECHNOLOGIES, LLC, Dearborn, MI (US)

(21) Appl. No.: 16/806,507

(22) Filed: Mar. 2, 2020

(30) Foreign Application Priority Data
Mar. 5, 2019 (DE) 10 2019 202 982.5

(51) Int. Cl. B60L 15/20; B60L 50/60

(52) U.S. Cl. CPC B60L 15/20; B60L 2240/12; B60L 50/66

(57) ABSTRACT

An electrified vehicle having a high-voltage source, such as a traction battery, includes at least one self-destructing or otherwise irreversibly disabling integrated circuit (IC) that may be activated by a controller in response to vehicle sensor data indicative of a situation that may expose rescue or recovery personnel to a possibility of electric shock. The IC(s) may be internal to a traction battery to disconnect or disable groups of cells from one another, and/or external to the traction battery to disconnect the high-voltage source from the vehicle electrical system.

### CROSS-REFERENCE TO RELATED APPLICATIONS

This application claims foreign priority benefits under 35 U.S.C. § 119(a)-(d) to DE Application 10 2019 202 982.5 filed Mar. 5, 2019, which is hereby incorporated by reference in its entirety.

### TECHNICAL FIELD

The present disclosure relates to a system and method for electronically controlled disconnection of a high-voltage source of an electrified vehicle.

### BACKGROUND

Motor vehicles comprising a motor-operated electric machine acting as a traction motor have a traction battery acting as an energy store. The motor vehicle may be a (battery) electric vehicle (B)EV or hybrid electric vehicle (HEV), for example a mild hybrid (MHEV), a full hybrid (FHEV), or a fuel cell electric vehicle (FCEV).

Such a traction battery is made up of several, up to thousands of battery cells or cell blocks which are interconnected in parallel and in series. The traction battery has a rated voltage of 350 to 400 volts. It forms a high-voltage component which should be electrically disconnected specifically in the case of a breakdown of other components of the motor vehicle, for example, the vehicle electrical system, to simplify recovery work and reduce the possibility of electric shock.

Various switching systems comprising circuit breakers or pyroelectric switches are known for electrically disconnecting the traction battery, for example, from U.S. Pat. Nos. 5,575,150 A, 9,755,417 B2, or DE 10 2009 020 559 B4.

### SUMMARY

One or more embodiments of the disclosure provide a system and method for disconnecting at least one high-voltage component of an electrified vehicle which is irreversibly electrically disconnected by a self-destructing integrated circuit (IC), which may include: recording vehicle and/or environmental data, evaluating the data, generating a disconnection signal in response to the data satisfying specified criteria, and activating the self-destructing IC via an activation signal, to irreversibly electrically disconnect the at least one high-voltage component from the vehicle electrical system.

As used herein, an IC is understood to mean an integrated circuit. It is an electronic circuit which is applied to a thin plate made of a semiconductor material which is usually several millimeters in size. It is sometimes also referred to as a solid-state circuit or monolithic integrated circuit. This die is usually encapsulated in a chip housing which is several times larger for protection and for simpler contacting. An IC typically contains a combination of numerous electronic semiconductor elements which are electrically interconnected, such as transistors, diodes, and/or other active and passive components. A self-destructing IC is understood to be an IC in which, by means of an activation signal, an irreversible self-destruction process can be triggered which involves making the IC permanently inoperative. This may involve electrical, chemical, or mechanical disabling or destruction of one or more circuits or components of the IC. Thus, a high-voltage component may not only be electrically disconnected, but rather, by means of the irreversible self-destruction of the IC, it is also ensured that the restoration of an electrical connection is eliminated, as would be the case, for example, with normal switching elements if they were to return from an open state to a closed state.

According to one embodiment, the vehicle and/or environmental data are indicative of a vehicle standstill and/or are indicative of an accident and may include a signal or sensor inside the vehicle and/or a signal or sensor outside the vehicle. If, for example, a vehicle standstill (0 km/h) was detected, this could be considered to be a potential situation where high-voltage sources should be disconnected because work on high-voltage components is carried out only with a standing motor vehicle. If, for example, accident detection exists, this is likewise seen as indicative of an accident and may be indicative of a situation where high-voltage sources may be disconnected to reduce possibility of electric shock. A signal inside the vehicle may, for example, be representative of overheating or another malfunction of a battery management system of the traction battery. If this is the case, this is considered to be indicative of a situation where disconnection of high-voltage sources is desired. A signal outside the vehicle may, for example, be transmitted by a rescue team to the vehicle with the aid of a suitable device, to ensure that the high-voltage component is irreversibly electrically disconnected prior to performing recovery work. Thus, by means of combined detection and evaluation of the data, possibility of electric shock may be reduced or eliminated.

According to another embodiment, an activation device guides a medium causing disabling or destruction of the IC to permanently disconnect the high-voltage source(s) from the vehicle electrical system. This may, for example, be acids which cause corrosion of the circuit and thus irreversible disabling or destruction of the IC to permanently disconnect the high-voltage source(s).

According to another embodiment, an activation device causes an energy flow causing permanent disablement or self-destruction to the self-destructing IC. This may be a heat flow or an electric current which causes heating of the self-destructing IC. By means of thermally induced mechanical stress, breaking of a stressed substrate of the IC, and thus irreversible self-destruction, can be effectuated.

Furthermore, the present disclosure includes embodiments of a computer program product, a control device, and a motor vehicle comprising such a control device for permanently disabling or destruction of an IC to disconnect one or more high-voltage sources from a vehicle electrical system.

### BRIEF DESCRIPTION OF THE DRAWINGS

FIG. 1 depicts a schematic representation of a motor vehicle comprising additional components.

FIG. 2 depicts a schematic representation of a flow chart of a method sequence of operation of the motor vehicle and the components depicted in FIG. 1.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

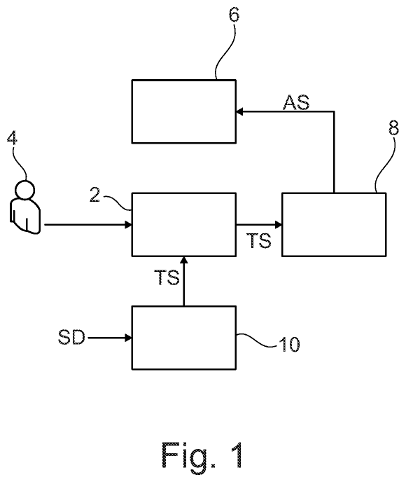

Reference will initially be made to FIG. 1. A motor vehicle 2 is depicted which is configured as a passenger vehicle in the present exemplary embodiment. The motor vehicle 2 comprises a motor-operated electric machine acting as a traction motor, which is at least partially supplied by a traction battery with electrical operating power. In other words, the motor vehicle 2 may be a (battery) electric vehicle ((B)EV) or hybrid electric vehicle (HEV), for example, a mild hybrid (MHEV), a full hybrid (FHEV), or a fuel cell electric vehicle (FCEV).

Such a traction battery is made up of several, up to thousands of battery cells or cell blocks which are interconnected in parallel and in series. The traction battery has a rated voltage of, for example, 350 to 400 volts. It forms a high-voltage source component that is desirable to be electrically disconnected or disabled specifically in the case of a breakdown of other components, for example, a vehicle electrical system of the motor vehicle 2, in order, for example, not to subject service personnel or rescue teams 4 carrying out recovery work to the possibility of electric shock.

In order to electrically disconnect or disable the high-voltage source(s) from other components of the motor vehicle 2, the motor vehicle 2 comprises disconnection or disabling integrated circuits (ICs) 6, an activation device 8, and a control device 10. The disconnection ICs 6 may be implemented between battery cells and/or cell blocks of the traction battery and/or between the traction battery and other components, for example, of the electrical system of the motor vehicle. The ICs 6 may be configured in such a way that they become irreversibly inoperable or self-destruct. In one or more embodiments, the ICs 6 become irreversibly inoperable when they come in contact with a predetermined medium, such as, for example, moisture, water, or chemical elements. The high-voltage source(s) may be disabled using the ICs 6 by severing or disconnecting internal connections between battery cells or groups of cells to reduce possibility of electrical shock because each individual cell typically has a voltage of less than 10 volts. Similarly, severing series connections between cells or groups of cells reduces the maximum current flow and therefore lowers possibility of electrical shock. Alternatively or in combination, ICs 6 may be placed to disconnect the traction battery from the other vehicle components, such as an inverter or DC-DC converter, for example.

Alternatively, the ICs 6 may be configured in such a way that irreversible self-destruction can be triggered by means of a predetermined energy flow to the ICs 6. The predetermined energy flow may be an electrical current or a heat flow, for example.

The ICs 6 may be supplied either with the predetermined medium or the predetermined energy flow by means of the activation device 8. For this purpose, the activation device 8 comprises, for example, medium-conducting pipes, heat conductors, or electrical conductors.

In the present exemplary embodiment, the ICs 6 are configured in such a way that they may be made permanently inoperable or self-destruct by means of an electric current in the form of an activation signal AS. The control unit 10 is configured to read in vehicle sensor data SD, to evaluate the data SD, and to generate a disconnection or termination signal TS if the data SD satisfy predetermined criteria indicative of a situation that may pose a possibility of electric shock from the high-voltage source(s), such as the vehicle traction battery.

The disconnection or termination signal TS may then, for example, be transmitted to the activation device 8 by means of a CAN bus of the motor vehicle 2. The activation device 8 then generates the activation signal AS, which is then likewise transmitted to the ICs 6, for example, by means of the CAN bus of the motor vehicle 2.

To determine whether a situation exists that warrants permanent disconnection of the high-voltage source(s), in the present exemplary embodiment, the control unit 10 reads in a vehicle speed of the motor vehicle 2 from one or more associated sensors as sensor data SD, and evaluates it. If, for example, a vehicle standstill (0 km/h) was detected, this may be considered to be indicative of a situation where it is desirable to permanently disconnect the high-voltage source(s). Of course, the vehicle speed data may be analyzed alone or with other sensor data SD to determine the context of the vehicle standstill, i.e. whether an accident has been detected, for example, and possibly the severity of the accident.

Furthermore, in the present exemplary embodiment, the control unit 10 reads in, as sensor data SD, whether, for example, accident detection exists. This may incorporate various vehicle sensor data, such as GPS, camera, lidar, radar, accelerometer, gyroscope, etc. Data collected from a paired mobile device may also be used. If accident detection exists, this is indicative of an accident and is thus considered to be a situation where permanent disconnection of the high-voltage sources may be desired.

In addition, in the present exemplary embodiment, the control unit 10 reads in, as sensor data SD, whether a signal inside the vehicle, for example, which is representative of overheating or another malfunction of a battery monitoring system of the traction battery, was detected. If this is the case, this is considered to be indicative of a situation where permanent disconnection or disabling of the high-voltage source(s) may be desired.

Finally, in the present exemplary embodiment, the control unit 10 reads in, as sensor data SD, whether a signal outside the vehicle exists. Such a signal outside the vehicle may, for example, be wirelessly transmitted by the rescue service 4 to the motor vehicle 2 with the aid of a suitable device, in order to ensure that the high-voltage source(s) are irreversibly electrically disconnected or disabled before the start of recovery work. Alternatively, a wired connection from the rescue service 4 to the motor vehicle 2 may be provided.

The control unit 10 may be connected in a data-transmitting manner to an HMI (human-machine interface) of the motor vehicle 2. This makes it possible to carry out status queries and to process the signals outside the vehicle.

Furthermore, an additional energy supply may be provided for supplying the control unit 10 with operating power and/or providing the ICs 6 with energy flow to disable or destroy the ICs 6 in response to the activation signal.

The control unit 10 may include control logic for evaluating the sensor data SD. In one or more embodiments, the control unit 10 includes a microprocessor or microcontroller having associated non-transitory memory containing instructions executable by the processor or controller to perform the various functions or steps of the methods described herein.

Furthermore, the control unit 10 has communication logic via which an operating status (blocked, activate, activated), for example, is transmitted to the HMI, or the signal outside the vehicle can be received by a device of the recovery team 4. For this purpose, a special, particularly secure transmission channel may be used.

In the “blocked” operating status, the control unit 10 is deactivated. No self-destruction and electrical disconnection have been initiated. In the “activate” operating state, an high-voltage source disconnection or disabling situation exists, and the ICs 6 are activated. This operating status is temporary. As soon as the operating status changes to “activate,” there is no possibility of returning to the “blocked” operating status.

In the “activated” operating status, after a certain period of time has elapsed after the “activate” operating status was triggered, one or more high-voltage components are irreversibly electrically disconnected or disabled to reduce the possibility of electrical shock. This can additionally be confirmed by sensors and communicated via the HMI or via a wired or wireless communication to a corresponding rescue or service tool or device.

For these tasks and functions and the ones described below, the control device 10, as well as the ICs 6 and/or the activation device 8, have hardware and/or software components.

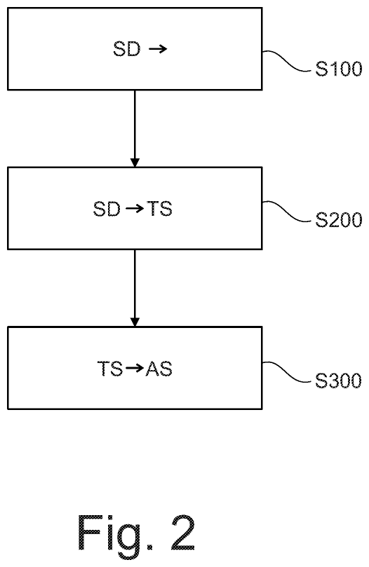

With additional reference to FIG. 2, a method sequence of operation of the motor vehicle 2 with its components will be described. As previously described, the flowchart or block diagram of FIG. 2 generally represents operation of a system or method by a programmed processor executing an algorithm to receive vehicle sensor data SD, analyze the sensor data, and directly or indirectly control various components, such as ICs 6 to selectively activate permanent disconnection or disabling of one or more high-voltage sources.

In a first step S100, the control unit 10 reads in the detected sensor data SD. The control unit 10 is in the “blocked” operating state. In a further step S200, the control unit 10 evaluates the sensor data SD and generates the disconnection or termination signal TS if the sensor data SD are indicative of a situation warranting disconnection or disabling of one or more high-voltage sources. The control unit 10 is now in the “activate” operating status.

The disconnection or termination signal TS is then transmitted to the activation device 8, whereupon then, in a further step S300, the activation signal AS is generated by the activation device 8, which then, after its transmission to the ICs 6, irreversibly electrically disconnects and/or disables the one or more high-voltage source(s) by means of self-destruction of the ICs 6. The control unit 10 is now in the “activated” operating status.

As such, various embodiments according to the disclosure reduce or eliminate the possibility of electric shock from vehicle high-voltage sources in response to detecting a situation that may expose personnel to vehicle components that are energized with high-voltage, such as during rescue or recovery operations.

While representative embodiments are described above, it is not intended that these embodiments describe all possible forms of the claimed subject matter. The words used in the specification are words of description rather than limitation, and it is understood that various changes may be made without departing from the spirit and scope of the claimed subject matter. Additionally, the features of various implementing embodiments may be combined to form further embodiments that may not be explicitly illustrated or described.

What is claimed is:

1. An electrified vehicle, comprising:
a high-voltage traction battery having a plurality of electrically connected cell groups;
an electric machine coupled to the traction battery and configured to provide propulsive force to vehicle wheels;
a vehicle speed sensor;
at least one integrated circuit (IC) configured to irreversibly electrically disable the traction battery from providing high-voltage power to at least the electric machine in response to a termination signal; and
a controller coupled to the vehicle speed sensor and the at least one integrated circuit, the controller programmed to receive a first signal from at least the vehicle speed sensor and to generate the termination signal to electrically disable the at least one IC in response to the first signal satisfying associated disconnection criteria.

2. The electrified vehicle of claim 1 wherein the disconnection criteria includes the electrified vehicle being at a standstill.

3. The electrified vehicle of claim 1 further comprising an activation device in communication with the controller, wherein, in response to the termination signal, the activation device guides a medium into contact with the at least one IC to electrically disable the at least one IC.

4. The electrified vehicle of claim 1 wherein the at least one IC is located within the traction battery.

5. The electrified vehicle of claim 1 wherein the at least one IC electrically disconnects at least one of the plurality of cell groups from another one of the plurality of cell groups in response to the termination signal.

6. The electrified vehicle of claim 1 wherein the controller is programmed to generate the termination signal in response to receiving the first signal from an external device.

7. The electrified vehicle of claim 6 wherein the first signal is wirelessly received from the external device.

8. The electrified vehicle of claim 1 further comprising an activation device in communication with the controller, wherein, in response to the termination signal, the activation device causes energy flow to the at least one IC to electrically disable the at least one IC.

9. A method for controlling an electrified vehicle having a high-voltage source, comprising, by a vehicle controller:
receiving sensor data from at least one vehicle sensor; and
communicating a termination signal to at least one integrated circuit (IC) in response to determining that the sensor data satisfies stored criteria indicative of a possibility of electrical shock from the high-voltage source to disable the high-voltage source, wherein the at least one IC irreversibly disables the high-voltage source from providing high-voltage power in response to the termination signal.

10. The method of claim 9 further comprising receiving the termination signal from an external device.

11. The method of claim 9 wherein the at least one vehicle sensor comprises a vehicle speed sensor.

12. The method of claim 9 wherein the at least one vehicle sensor indicates that the electrified vehicle is at a standstill.

13. The method of claim 9 wherein the at least one IC is located within the high-voltage source.

14. The method of claim 9 wherein the high-voltage source comprises a traction battery having a plurality of cell groups, and wherein the at least one IC disconnects one of the plurality of cell groups from another of the plurality of cell groups in response to the termination signal.

15. The method of claim 9 wherein communicating the termination signal comprises communicating the termination signal to an activation device that guides a medium into contact with the at least one IC to electrically disable the at least one IC.

16. An electrified vehicle, comprising:
a high-voltage battery having a plurality of electrically connected cell groups;
an electric machine coupled to the battery and configured to provide propulsive force to vehicle wheels;
a vehicle speed sensor;
at least one self-destructing integrated circuit (IC) configured to irreversibly electrically disable the battery from providing high-voltage power to at least the electric machine in response to a termination signal; and
a controller coupled to the vehicle speed sensor and the at least one IC, the controller configured to receive vehicle sensor data from at least the vehicle speed sensor and to generate the termination signal in response to the sensor data indicating a potential possibility of electrical shock from the battery.

17. The electrified vehicle of claim 16 wherein the sensor data includes a wirelessly received disconnection signal transmitted by an external device.

18. The electrified vehicle of claim 16 further comprising an activation device that guides a medium into contact with the at least one IC to destroy the at least one IC.

19. The electrified vehicle of claim 16 wherein the at least one IC is configured to disconnect one of the plurality of cell groups from another one of the plurality of cell groups in response to the termination signal.

20. The electrified vehicle of claim 16 wherein the controller is programmed to transmit a verification of disconnection signal in response to detecting that the battery has been disabled.
